(19) United States
(12) Patent Application Publication
(10) Pub. No.: US 2003/0062462 A1
(43) Pub. Date: Apr. 3, 2003

(54) Vehicle seat subassembly, in particular motor-vehicle seat adjuster

(76) Inventor: Hermann Jost, Kaiserslautern (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/245,061

(22) Filed: Sep. 17, 2002

(30) Foreign Application Priority Data
Sep. 29, 2001 (DE) 101 48 369.4

(51) Int. Cl. F16M 13/00

(52) U.S. Cl. 248/430

(57) ABSTRACT

In the case of a vehicle-seat subassembly, in particular in the case of a motor-vehicle seat adjuster, having a first component (11) which defines an axial direction, and a second component (20) which is fixed in the axial direction at a certain point of the first component (11), the two components (11, 20) being subject to tension or compression in the axial direction during use of the vehicle-seat subassembly, the two components (11, 20) are connected to each other by displacement of material (17′) of at least one component (11).

### BACKGROUND OF THE INVENTION

The invention relates to connecting components of a vehicle-seat subassembly and, more particularly, to connecting components of a motor-vehicle seat adjuster.

In the case of a known vehicle-seat subassembly, which is used as a longitudinal adjuster for a motor-vehicle seat, a claw-shaped locking element is provided for locking the seat rails. The locking element is fixed on a bolt. At a certain point, a securing ring is pushed onto the bolt. The securing ring is guided along the bolt in the axial direction of the bolt. The securing ring is used to introduce the closing force, which is produced by a compression spring, into the bolt and therefore into the locking element. Exact positioning of the securing ring is desirable so as not to cause either an excessively high minimum stroke, against which unlocking is impossible in an extreme case, or an excessively small closing force, which results in play, which produces rattling noises. However, the exact positioning is labor-consuming and therefore costintensive.

There is also the risk of the two components, i.e., the securing ring and the bolt, being displaced relative to each other after installation, for example during transportation. An increase in the radially acting force which fixes the securing ring in order to avoid this risk would lead to difficulties during installation.

### BRIEF SUMMARY OF THE INVENTION

One aspect of the present invention is the provision of an improved vehicle-seat subassembly that includes first and second components, with displaced material of at least one of the first and second components connecting the first and second components to each other so that the second component is fixed in the axial direction of the first component at a predetermined point of the first component. In accordance with this aspect, the connected-together first and second components are subject to tension or compression in the axial direction during use of the vehicle-seat subassembly.

Because the two components are connected to each other by displacement of material of at least one component, exact positioning at a certain, defined point of the first component, which is of elongate design, is achieved, which point can be highly loaded and is also simple to fit. Relative displacements are prevented. The resistance to forces acting on one side is increased. The dimensions required for use are kept exact. Relative rotation is preferably also prevented. The connection of the two components is preferably interlocking on both sides in the axial direction, in order to keep the exact dimensions irrespective of the loading direction.

The two components are preferably connected by riveting, for example by annular riveting, center-punch riveting or wobble riveting. As a preferred support, a shoulder which is effective in the axial direction is formed in an end section of the first component. The second component, which is designed as a disk or saucer, bears against the shoulder and is riveted on the side facing away from the shoulder. A symmetrical design of the disk prevents installation errors due to mirror-inverted assembly. The material displaced during the riveting process preferably comes from the end section, for example from an annular wall, a section of material which has been cut out, or from another region of the end section. The displaced material, which grips behind the second component, is preferably pressed into a bevel or other pocket of the second component in order to leave the external dimensions of the interconnected components unchanged, in particular in order not to enlarge the axial length of the subassembly by means of a rivet head.

### BRIEF DESCRIPTION OF THE DRAWINGS

The invention is explained in greater detail below with reference to two exemplary embodiments which are illustrated in the drawings, in which:

FIG. 1 shows a view of a bolt according to the first exemplary embodiment before the riveting process,

FIG. 2 shows a section through the bolt of FIG. 1 after the riveting process,

FIG. 3 shows a partially cut-away view of a bolt according to the second exemplary embodiment before the riveting process,

FIG. 4 shows a section through the first exemplary embodiment in the region of the bolt, and

FIG. 5 shows a modification of the first exemplary embodiment.

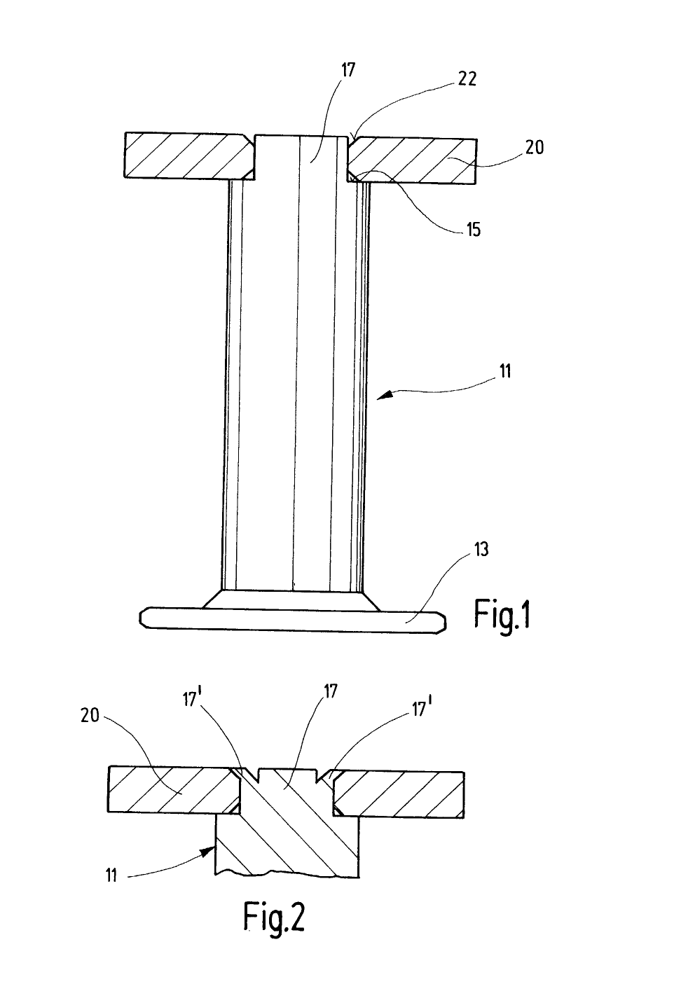

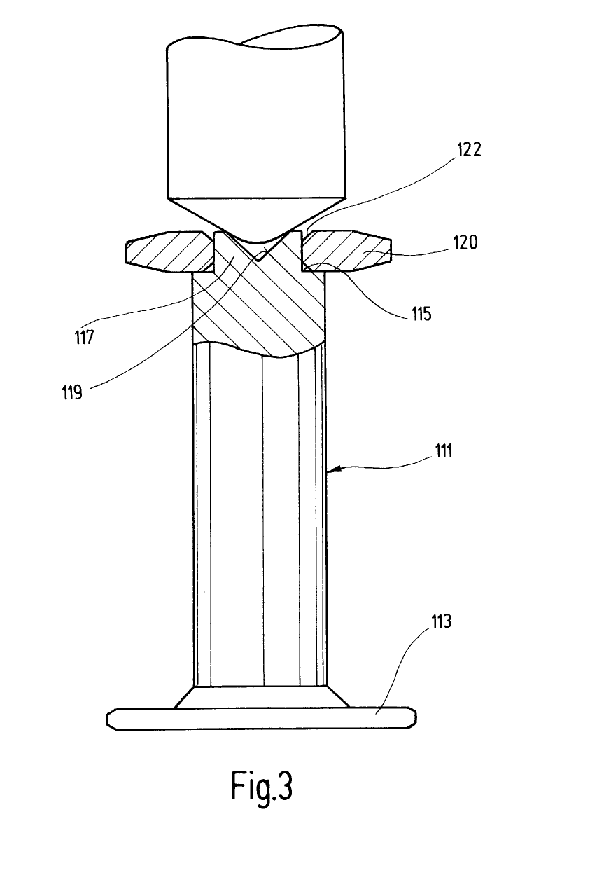

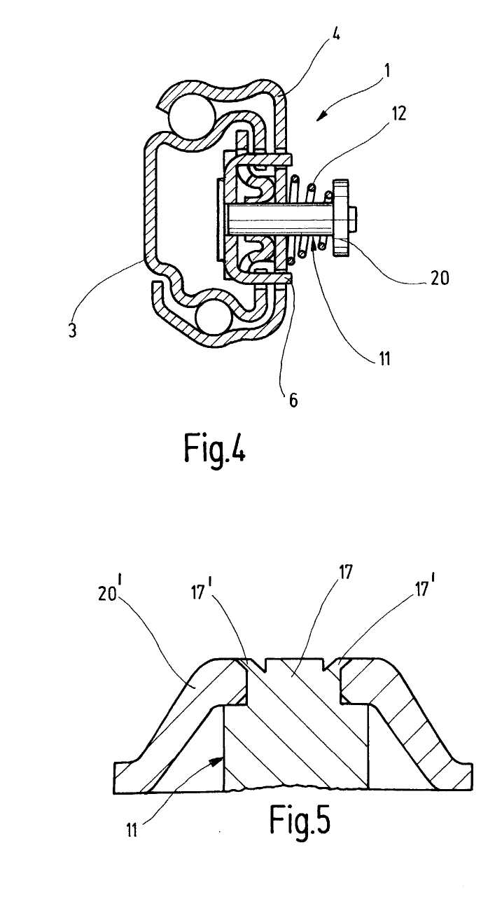

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements.

In the exemplary embodiments, a vehicle-seat subassembly 1 is designed as a longitudinal adjuster for a motor-vehicle seat. The vehicle-seat subassembly 1 has an inner lower rail 3, which is fixed on the vehicle structure, and an outer upper rail 4 which is fixed on the seat structure and is guided in a sliding manner on the lower rail 3. A claw 6, which is arranged moveably transversely to the rails 3 and 4, is provided for locking the rails 3 and 4. The claw 6, in the locked state, penetrates with a plurality of fingers the walls of both rails 3 and 4, which walls are provided with corresponding openings or cutouts.

For guidance and application of force, the claw 6 is fastened on a bolt 11. The bolt 11, which can be characterized as a first component, is guided in the axial direction in the upper rail 4 (e.g., the bolt 11 extends through an opening in the upper rail 4 so that the bolt can be moved in the axial direction of the bolt relative to the rails). At the end of the bolt 11 facing away from the claw 6, outside the upper rail 4, a disk 20, which can be characterized as a second component, is provided in a manner described below. A prestressed compression spring 12, which is arranged between the outside of the upper rail 4 and the disk 20, subjects the claw to a closing tensile force via the bolt 11. In order to unlock the claw 6, the claw 6 is pushed back via the bolt 11, which is to be moved in the axial direction, until it releases both rails 3 and 4.

In the first exemplary embodiment, the bolt 11 has a cylindrical basic shape over the majority of its length, which shape defines the directional details which are used. A flange 13 projecting in the radial direction is integrally formed on one axial end of the bolt 11. In the region of its other axial end, the bolt 11 has a step. The step includes an annular shoulder 15 which extends in the radial direction. The step defines a cylindrical end section 17.

The annular disk 20 has a respective bevel 22 of 45° in the transition region between its opening situated on the inside and the end sides. The diameter of the disk 20 is greater than the diameter of the bolt 11, for example is as large as the diameter of the flange 13.

The disk 20 is pushed onto the end section 17 of the bolt 11 and is brought to bear against the shoulder 15. By means of annular riveting, the material is cut into annularly on the end side of the end section 17 and the region situated further to the outside is displaced outward so that a section 17′ of material grips in an interlocking manner behind the disk 20, with the result that the disk is fixed in the axial direction. The gripping-behind action takes place in the region of the bevel 22 which is arranged further outward axially, with the result that material does not protrude in the axial direction over the end side of the end section 17 and of the disk 20. The shoulder 15 therefore defines, on the bolt 11 as a first component, a certain point at which the disk 20, as a second component, is fixed in the axial direction.

In a modification, illustrated in FIG. 5, of the first exemplary embodiment, instead of the disk 20 (e.g., second component) a saucer 20′, the edge of which is drawn in the direction of the flange 13, is provided. The compression spring 13 is then seated with a number of coils within the saucer 20′, which brings about more favorable behavior during compression. Otherwise, the modification corresponds to the first exemplary embodiment.

The second exemplary embodiment largely corresponds with the first exemplary embodiment and so elements which are identical and act in an identical manner bear reference numbers which are higher by 100.

Apart from the flange 113, the shoulder 115 and the end section 117, the bolt 111 also has a conical center socket 119. The center socket 119 is formed centrally in the end-side end section 117 and tapers into the interior of the bolt 111.

The disk 120 having the bevels 122 is placed on the bolt 111 in the same manner as described for the first embodiment. By means of center-punch riveting, the material of the end section 117, which forms the wall of the center socket 119, is at least partially displaced outward where it grips in an interlocking manner behind the disk 120, in the region of the corresponding bevel 122, and fixes the disk in the axial direction.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A vehicle-seat subassembly, comprising:
a first component which defines an axial direction;
a second component, wherein displaced material of at least one of the first and second components connects the first and second components to each other so that the second component is fixed in the axial direction at a predetermined point of the first component; and
a third component, wherein the connected-together first and second components are mounted to the third component for moving in the axial relative to the third component and for being subject to tension or compression in the axial direction.

2. A vehicle-seat subassembly according to claim 1, wherein the first component includes opposite sides which are spaced apart from one another in a direction that is transverse to the axial direction, and said displaced material interlocks the first and second components with each other proximate both of the opposite sides.

3. A vehicle-seat subassembly according to claim 1, wherein the first component extends through an opening in the second component, the second component includes opposite sides, a support of the first component is adjacent a first of the sides of the second component, said displaced material is part of the first component and is adjacent a second of the sides of the second component, and said displaced material and the support respectively interact with the second and first sides so that the second component is fixed in the axial direction at the predetermined point of the first component, wherein the displaced material was displaced while the first component is extending through the opening in the second component and the support is adjacent the first side, such that the first and second components are riveted together.

4. A vehicle-seat subassembly according to claim 1, wherein an end section of the first component includes a shoulder that extends transverse to the axial direction.

5. A vehicle-seat subassembly according to claim 4, wherein the second component engages the shoulder, and the second component is a disk or a saucer.

6. A vehicle-seat subassembly according to claim 3, wherein said displaced material is at an end section of the first component, said displaced material defines a shape resulting from said displaced material having been displaced at least partially radially outward relative to the axial direction, and the support of the first component is a shoulder that extends transverse to the axial direction.

7. A vehicle-seat subassembly according to claim 6, wherein said displaced material defines a shape resulting from said displaced material having been at least partially cut from the end section of the first component and displaced at least partially radially outward relative to the axial direction.

8. A vehicle-seat subassembly according to claim 6, wherein said displaced material defines a shape resulting from said displaced material having defined a socket and thereafter the displaced material having been displaced at least partially radially outward relative to the axial direction.

9. A vehicle-seat subassembly according to claim 6, wherein the second side of the second component faces away from the shoulder, and said displaced material is engaged against the second side of the second component.

10. A vehicle-seat subassembly according to claim 1, wherein the second component has a bevel surface, said displaced material is a portion of the first component, and said displaced material engages against the bevel surface.

11. A vehicle-seat subassembly according to claim 6, wherein the second surface of the second component is beveled and faces away from the shoulder, and said displaced material is engaged against the beveled second surface.

12. A vehicle-seat subassembly according to claim 1, wherein:
the first component extends through an opening in the second component,
the second component includes opposite sides,
a support of the first component is adjacent a first of the sides of the second component,
the displaced material is part of the first component and engages a second of the sides of the second component,
the support and said displaced material respectively interact with the first and second sides so that the second component is fixed in the axial direction at the predetermined point of the first component,
said displaced material was displaced while the first component is extending through the opening in the second component and the support is adjacent the first side of the second component, and
the third component includes:
a first adjuster portion that is mounted for moving relative to a second adjuster portion, with the connected-together first and second components being mounted to the first adjuster portion for moving with the first adjuster portion relative to the second adjuster portion,
a locking element mounted to a first end of the first component, wherein the second component is mounted to a second end of the first component, and
a spring mounted for biasing the second component away from the first adjuster portion and for biasing the locking element into locking engagement with at least the second adjuster portion for restricting movement of the first adjuster portion relative to the second adjuster portion.

13. A method for a vehicle-seat subassembly, comprising:
passing a first component through an opening in a second component;
connecting the first and second components to each other so that the second component is fixed in an axial direction of the first component at a predetermined point of the first component, with the connecting including displacing material of at least one of the first and second components while the first component is extending through the opening in the second component; and
adjusting the vehicle-seat subassembly, including subjecting the connected-together first and second components to tension or compression in the axial direction.

14. A method according to claim 13, wherein the first component includes opposite sides which are spaced apart from one another in a direction that is transverse to the axial direction, and the displacing includes displacing material of the first component so that the displaced material interlocks the first and second components with each other proximate both of the opposite sides.

15. A method according to claim 13, wherein the displacing includes riveting the first and second components to each other.

16. A method according to claim 13, wherein:
the second component includes opposite sides,
the passing the first component through the opening in the second component includes engaging a first of the sides of the second component against a support, and
the displacing includes displacing material of the first component at a position adjacent a second of the sides of the second component, while the first component is extending through the opening and the first side is engaged against the support.

17. A method according to claim 16, wherein engaging the first side against the support includes engaging the first side against a shoulder of the first component, with the shoulder extending transverse to the axial direction.

18. A method according to claim 16, wherein the displacing includes displacing material from an end section of the first component at least partially radially outward relative to the axial direction.

19. A method according to claim 18, wherein the displacing includes at least partially cutting a portion of the end section of the first component and displacing the cut portion at least partially radially outward relative to the axial direction.

20. A method according to claim 18, wherein the displacing includes displacing a wall of a socket of the first component at least partially radially outward relative to the axial direction.

21. A method according to claim 16, wherein the displacing includes engaging the displaced material against a bevel surface of the second component.

22. A method according to claim 16, wherein the adjusting includes moving the connected-together first and second components to unlock a locking element, causing relative movement between predetermined portions of the vehicle-seat subassembly while the locking element is unlocked, and then moving the connected-together first and second components to lock the locking element and thereby restrict relative movement between the predetermined portions of the vehicle-seat subassembly.
